(19) United States
(12) Patent Application Publication
(10) Pub. No.: US 2026/0149923 A1
(43) Pub. Date: May 28, 2026

(54) AUDIO SYSTEM FOR VEHICLE

(71) Applicant: Tymphany HK Limited, Hong Kong (HK)

(72) Inventor: Gavin Jones, Taipei City (TW)

(21) Appl. No.: 19/177,865

(22) Filed: Apr. 14, 2025

Related U.S. Application Data
(60) Provisional application No. 63/646,256, filed on May 13, 2024.

(51) Int. Cl. H04R 3/12

(52) U.S. Cl. CPC H04R 3/12; H04R 2499/13

(57) ABSTRACT

An audio system for a vehicle includes a loudspeaker array and an audio signal processing system. The loudspeaker array includes a first front loudspeaker, a first rear loudspeaker and a second rear loudspeaker arranged in a triangle. The first front loudspeaker is closer to a reflective surface in comparison with the first rear loudspeaker and the second rear loudspeaker. The audio signal processing system provides a principal signal and an accommodating signal of a first audio channel to the first front loudspeaker and the first rear loudspeaker, and provides a principal signal and an accommodating signal of a second audio channel to the first front loudspeaker and the second rear loudspeaker such that the loudspeaker array generates a directional radiation pattern directed to a reflecting surface in the vehicle and reflected to the occupant in the vehicle.

### CROSS-REFERENCE TO RELATED APPLICATIONS

This application claims priority of U.S. Provisional Application No. 63/646,256 filed on May 13, 2024 under 35 U.S.C. § 119(e), the entire contents of all of which are hereby incorporated by reference.

### TECHNICAL FIELD

The present invention is related to the field of audio technology, and in particular, to an audio system for a vehicle.

### BACKGROUND OF THE INVENTION

In the current development, many audio systems for vehicles are designed to provide an immersive audio experience to occupants of the vehicles. Automotive audio technology has evolved dramatically from the early days of an automotive audio system having a single loudspeaker to an automotive audio system having two loudspeakers. Today, a vehicle is usually equipped with multiple loudspeakers and perhaps even one or more sub-woofers to provide a more immersive audio experience and support for multi-channel audio.

However, even though the immersive audio experience provided by existing automotive audio systems has been improved, there is still room for improvement in the quality of the immersive experience, and there is a need to simplify the manufacturing and installation of existing automotive audio systems. Therefore, addressing the shortcomings of the existing technology is indeed necessary to propose a better solution.

### SUMMARY OF THE INVENTION

In view of the deficiencies in the art, the main object of the present invention is to provide an audio system for a vehicle and improve the quality of the audio experience by improving the structure of the audio system.

In order to solve the problem in the art, the audio system provided in the present invention includes a loudspeaker array, comprising a first front loudspeaker, a first rear loudspeaker and a second rear loudspeaker, wherein the first front loudspeaker, the first rear loudspeaker and the second rear loudspeaker are arranged in a triangle, and the first front loudspeaker is closer to a reflecting surface in comparison with the first rear loudspeaker and the second rear loudspeaker; and an audio signal processing system, configured to process a plurality of audio channels, wherein the audio signal processing system is configured to provide a first principal signal and a first accommodating signal of a first audio channel in the plurality of audio channels to the first front loudspeaker and the first rear loudspeaker respectively, and the audio signal processing system is configured to provide a second principal signal and a second accommodating signal of a second audio channel in the plurality of audio channels to the first front loudspeaker and the second rear loudspeaker respectively, such that the loudspeaker array generates a directional radiation pattern and the directional radiation pattern is directed to the reflecting surface.

According to the aforementioned structure, when the audio system of the present invention is installed in a vehicle, the first front loudspeaker, the first rear loudspeaker and the second rear loudspeaker are arranged in a triangle, and the first front loudspeaker is closer to the reflecting surface in the vehicle in comparison with the first rear loudspeaker and the second rear loudspeaker such that the directional radiation pattern generated by the loudspeaker array is directed to the reflecting surface and is reflected to the occupant in the vehicle by the reflecting surface. Therefore, the occupant can perceive the sound from different positions in the vehicle and the quality of the audio experience is thus improved.

In order to solve the aforementioned problem in the art, the present invention provides another audio system including a loudspeaker array, comprising a first front loudspeaker, a second front loudspeaker, a first rear loudspeaker and a second rear loudspeaker, wherein the first front loudspeaker, the first rear loudspeaker and the second rear loudspeaker are arranged in a triangle, the second front loudspeaker, the first rear loudspeaker and the second rear loudspeaker are arranged in another triangle, and the first front loudspeaker and the second front loudspeaker are closer to a reflecting surface in comparison with the first rear loudspeaker and the second rear loudspeaker; and an audio signal processing system, configured to process a plurality of audio channels, wherein the audio signal processing system is configured to provide a first principal signal and a first accommodating signal of a first audio channel in the plurality of audio channels to the first front loudspeaker and the first rear loudspeaker respectively, and the audio signal processing system is configured to provide a second principal signal and a second accommodating signal of a second audio channel in the plurality of audio channels to the second front loudspeaker and the second rear loudspeaker respectively, such that the loudspeaker array generates a directional radiation pattern and the directional radiation pattern is directed to the reflecting surface.

According to the aforementioned structure, when the audio system of the present invention is installed in a vehicle, the first front loudspeaker, the first rear loudspeaker and the second rear loudspeaker are arranged in a triangle, the second front loudspeaker, the first rear loudspeaker and the second rear loudspeaker are arranged in another triangle, and the first front loudspeaker and the second front loudspeaker are closer to the reflecting surface in the vehicle in comparison with the first rear loudspeaker and the second rear loudspeaker such that the directional radiation pattern generated by the loudspeaker array is directed to the reflecting surface and is reflected to the occupants in the vehicle by the reflecting surface. Therefore, the occupants can perceive the sound from different positions in the vehicle and the quality of the audio experience is thus improved.

### BRIEF DESCRIPTION OF DRAWINGS

FIG. 1 is a schematic diagram of the structure of an audio system for a vehicle according to a first embodiment of the present invention.

FIG. 2 is a top view of a loudspeaker array of the audio system according to the first embodiment of the present invention.

FIG. 3 is the stereo view of the loudspeaker array of the audio system according to the first embodiment of the present invention.

FIG. 4 is a schematic diagram of the application state of the audio system according to the first embodiment of the present invention.

FIG. 5 is a schematic diagram of the structure of the audio system according to a second embodiment of the present invention.

FIG. 6 is a top view of a loudspeaker array of the audio system according to the second embodiment of the present invention.

FIG. 7 is a schematic diagram showing the state of a directional radiation pattern generated by the audio system of the present invention.

FIG. 8 to FIG. 10 illustrate the effects of changes in the characteristics of the accommodating signal on the directional radiation pattern.

### DETAILED DESCRIPTION OF THE INVENTION

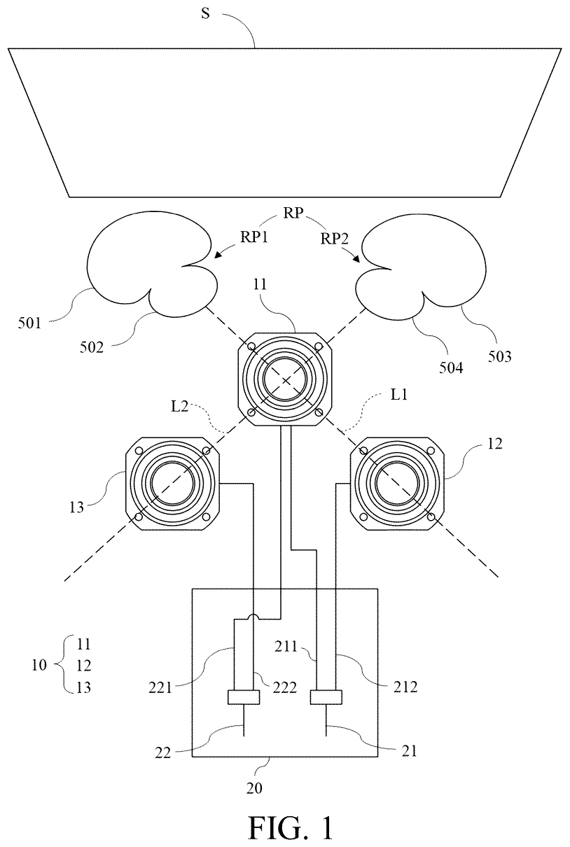

FIG. 1 shows an audio system for a vehicle according to a first embodiment of the present invention. The audio system comprises a loudspeaker array 10 and an audio signal processing system 20. The loudspeaker array 10 is electrically connected to the audio signal processing system 20. The loudspeaker array 10 comprises a first front loudspeaker 11, a first rear loudspeaker 12 and a second rear loudspeaker 13. The first front loudspeaker 11, the first rear loudspeaker 12 and the second rear loudspeaker 13 are arranged in a triangle. The first front loudspeaker 11 is closer to a reflecting surface S in comparison with the first rear loudspeaker 12 and the second rear loudspeaker 13.

The audio signal processing system 20 is configured to process a plurality of audio channels. The audio signal processing system 20 is configured to provide a first principal signal 211 and a first accommodating signal 212 of a first audio channel 21 in the plurality of audio channels to the first front loudspeaker 11 and the first rear loudspeaker 12 respectively. The audio signal processing system 20 is also configured to provide a second principal signal 221 and a second accommodating signal 222 of a second audio channel 22 of the plurality of audio channels to the first front loudspeaker 11 and the second rear loudspeaker 13 respectively. Therefore, the loudspeaker array 10 generates a directional radiation pattern RP, and the directional radiation pattern RP is directed to a reflecting surface S.

In the first embodiment, the loudspeaker array 10 may be installed on a dashboard, a trunk, a door or a shelf in a vehicle, or on other arbitrary surfaces located in a passenger compartment. The reflecting surface S may be a windshield, a headliner, a side window, a door, a rear window or a shelf of the vehicle. The loudspeakers described herein (e.g., the loudspeakers 11, 12, 13, 14 and/or other described loudspeakers) may constitute individual drivers in the loudspeaker system. These loudspeakers contain drivers having a diameter from 30 mm (millimeters) to 80 mm (e.g., 50 mm drivers).

According to the aforementioned structure, when the audio system of the present invention is installed in the vehicle, the first front loudspeaker 11, the first rear loudspeaker 12 and the second rear loudspeaker 13 of the loudspeaker array 10 are arranged in a triangle, and the first front loudspeaker 11 is closer to a reflecting surface S in the vehicle in comparison with the first rear loudspeaker 12 and the second rear loudspeaker 13 such that the directional radiation pattern RP generated by the loudspeaker array 10 is directed to the reflecting surface S and is reflected to the occupant(s) in the vehicle by the reflecting surface. Therefore, the occupant can perceive the sound from different positions in the vehicle to improve the quality of audio experience.

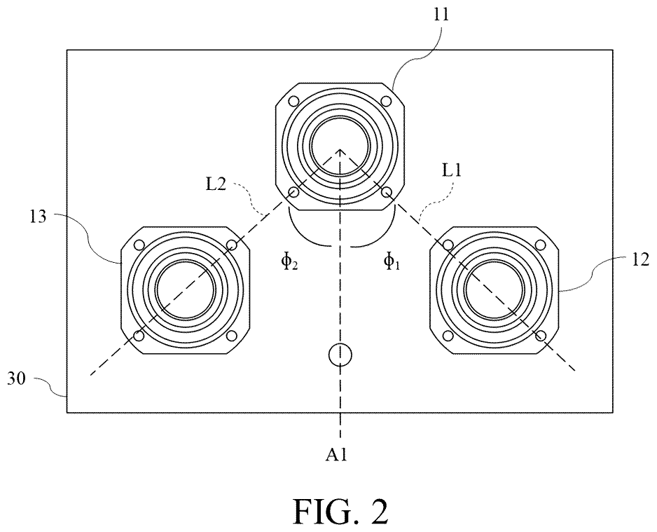

Referring to FIG. 1 and FIG. 2, the arrangement of the loudspeakers in the loudspeaker array 10 is described below. In this embodiment, the first front loudspeaker 11, the first rear loudspeaker 12 and the second rear loudspeaker 13 are respectively installed on a flat plate-shaped baffle 30. The first front loudspeaker 11 is located between the first rear loudspeaker 12 and the second rear loudspeaker 13. The first front loudspeaker 11 is at an offset position (e.g., a horizontally offset position) with respect to the first rear loudspeaker 12 and the second rear loudspeaker 13 such that the first front loudspeaker 11, the first rear loudspeaker 12 and the second rear loudspeaker 13 are arranged on the baffle 30 in the form of an equilateral triangle, an isosceles triangle or a scalene triangle.

In the first embodiment, a connection from an acoustic center of the first front loudspeaker 11 to the acoustic center of the first rear loudspeaker 12 is defined as a first line segment L1, a connection from the acoustic center of the first front loudspeaker 11 to the acoustic center of the second rear loudspeaker 13 is defined as a second line segment, and an included angle is defined by the first line segment L1 and the second line segment L2. Through the offset, the spacing distance from the first front loudspeaker 11 to the first rear loudspeaker 12 and the spacing distance from the first front loudspeaker 11 to the second rear loudspeaker 13 are different. An included angle between the first line segment L1 and the second line segment L2 may range between 90°and 100°or range between 60°and 140°so as to adapt to different installation spaces. Certainly, other offset positions can be used to provide other included angles, depending on the specific requirements.

Furthermore, as shown in FIG. 2, the loudspeaker array 10 of this embodiment includes a backward axis A1. A first reference included angle Φ1 is defined by the backward axis A1 and the first line segment L1. A second reference included angle Φ2 is defined by the backward axis A1 and the second line segment L2. A first reference included angle Φ1 and a second reference included angle Φ2 constitute the included angles defined by the first line segment L1 and the second line segment L2. In this embodiment, the first reference included angle Φ1 may be the same or different from the second reference included angle Φ2, and the first reference included angle Φ1 and the second reference included angle Φ2 respectively range between 45°and 50°or range between 30°and 70°.

In this embodiment, a first spacing distance is defined by the first front loudspeaker 11 and the first rear loudspeaker 12, and a second spacing distance is defined by the first front loudspeaker 11 and the second rear loudspeaker 13. The first spacing distance and the second spacing distance are respectively set to a quarter wavelength of an operating frequency of the audio system of the present invention. For example, the operating frequency of the audio system of the present invention can range between 500 Hz and 5 kHz, and the first spacing distance and the second spacing distance can respectively range between 50 mm and 200 mm.

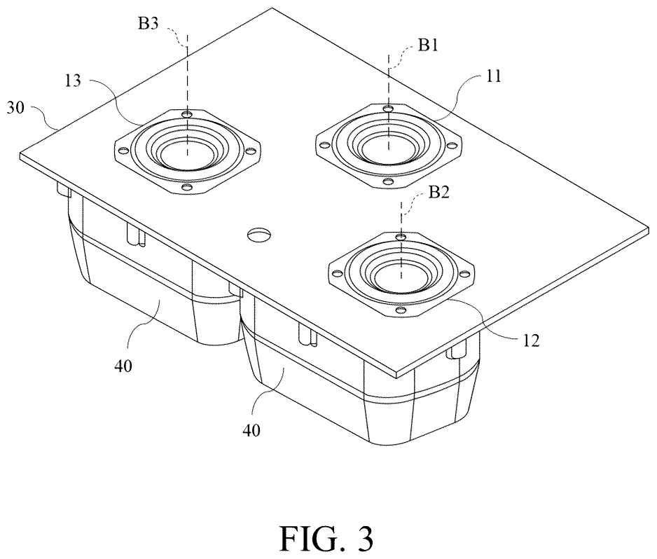

Referring to FIG. 2 and FIG. 3, in order to enhance the audio experience of the audio system of the present invention, the baffle 30 of this embodiment is arranged on a plane that is a substantially horizontal plane such that the acoustic centers of the first front loudspeaker 11, the first rear loudspeaker 12 and the second rear loudspeaker 13 are basically located on the same horizontal plane so as to present a coplanar configuration. In such a configuration, the first front loudspeaker 11, the first rear loudspeaker 12 and the second rear loudspeaker 13 are not offset from each other in the vertical direction or are slightly offset from each other, and the longitudinal directions B1, B2, B3 respectively passing through the acoustic centers of the first front loudspeaker 11, the first rear loudspeaker 12, and the second rear loudspeaker 13 are substantially parallel to each other such that the first front loudspeaker 11, the first rear loudspeaker 12 and the second rear loudspeaker 13 are respectively configured to emit sound upwards. It is noted that in a different embodiment, the baffle 30 is not necessarily arranged on a plane that is a substantially horizontal plane. The baffle 30 may be provided with a curved surface, as long as the acoustic centers of the first front loudspeaker 11, the first rear loudspeaker 12 and the second rear loudspeaker 13 are arranged on the baffle 30 in the form of an equilateral triangle, an isosceles triangle or a scalene triangle. In another embodiment, the longitudinal directions B1, B2, B3 respectively passing through the acoustic centers B1, B2, B3 of the first front loudspeaker 11, the first rear loudspeaker 12 and the second rear loudspeaker 13 may be slightly offset from each other such that the longitudinal directions B1, B2, B3 cross one another instead of being parallel to one another. In addition, other relative positions between loudspeakers can also be adopted here. For example, loudspeaker pairs in the loudspeaker array 10 may be vertically offset from each other, or a loudspeaker in the loudspeaker array 10 may rotate with respect to the baffle 30 to make the longitudinal directions of two or more loudspeakers not parallel to each other.

In this embodiment, the audio system of the present invention further comprises a plurality of housings 40, and the plurality of housings 40 are respectively arranged below the baffle 30 and respectively cover the undersides of the first front loudspeaker 11, the first rear loudspeaker 12 and the second rear loudspeaker 13 so as to prevent each loudspeaker from being damaged by contact with dust, water vapor, or external impact, thereby prolonging the service life of each loudspeaker.

FIG. 1 is an illustration of how the audio signal processing system 20 provides the principal signal and the accommodating signal. In this embodiment, the audio signal processing system 20 can be implemented by one or more digital processors and provides a first audio channel 21 and a second audio channel 22. The first audio channel 21 and the second audio channel 22 are respectively a left audio channel and a right audio channel (details described hereinafter) of a stereo sound signal that are transmitted to the corresponding occupants in the vehicle.

In this embodiment, a first principal signal 211 of the first audio channel 21 is an unprocessed signal (such as a signal not processed by inverting, phase-shifting, delaying or filtering) corresponding to the first audio channel 21. Based on this first audio channel 21, a first accommodating signal 212 is generated. The first accommodating signal 212 is a signal processed and provided to the first audio channel 21, or is the processed first principal signal 211. That is, the first accommodating signal 212 is a processed signal (e.g., inverted, phase shifted, delayed, or filtered, etc.) corresponding to the first audio channel 21. For example, the first accommodating signal 212 of the first audio channel 21 is generated by filtering, delaying or inverting the first principal signal 211 of the first audio channel 21.

The second principal signal 221 of the second audio channel 22 is an unprocessed (e.g., not inverted, phased, delayed or filtered) signal corresponding to the second audio channel 22. Moreover, based on the second audio channel 22, a second accommodating signal 222 is generated. The second accommodating signal 222 is a signal processed and provided to the second audio channel 22, or is the processed second principal signal 221. That is, the second accommodating signal 222 is a processed signal (e.g., inverted, phase shifted, delayed, or filtered, etc.) corresponding to the second audio channel 22. For example, the second accommodating signal 222 of the second audio channel 22 is generated by filtering, delaying or inverting the second principal signal 221 of the second audio channel 22.

In this embodiment, the first accommodating signal 212 and the second accommodating signal 222 of the present invention are generated by using various approaches. For example, an audio signal processing system 20 comprises a signal inverter. The signal inverter is used for inverting the first principal signal 211 or the second principal signal 221 to generate the first accommodating signal 212 or the second accommodating signal 222. Alternatively, the first accommodating signal 212 or the second accommodating signal 222 is generated by supplying delay or phase shift to the first principal signal 211 or the second principal signal 221. The first accommodating signal 212 or the second accommodating signal 222 can be generated by applying different delays. In addition, the audio signal processing system 20 may comprise one or more filters. The one or more filters are provided for filtering the first principal signal 211 or the second principal signal 221 to generate the first accommodating signal 212 or the second accommodating signal 222. The filtering process of the one or more filters can include a low-pass filter, a high-pass filter, and a band-pass filter. In addition to inverting, supplying delay and filtering, the first accommodating signal 212 and the second accommodating signal 222 can also be mixed, additively accommodating, and voltage level accommodating by a Digital Signal Processor (DSP) or other processing circuits.

As shown in FIG. 1, in this embodiment, the first front loudspeaker 11 is used for receiving the first principal signal 211 and the second principal signal 221 from the audio signal processing system 20, and the first rear loudspeaker 12 and the second rear loudspeaker 13 are respectively used for receiving the first accommodating signal 212 and the second accommodating signal 222 from the audio signal processing system 20, so as to generate the directional radiation pattern RP. The directional radiation pattern RP further comprises a first directional radiation pattern RP1 and a second directional radiation pattern RP2. In this embodiment, the first directional radiation pattern RP1 is approximately located in a direction parallel to the first line segment L1 and comprises a first forward component 501 and a first backward component 502. The second directional radiation pattern RP2 is approximately located in a direction parallel to the second line segment L2 and comprises a second forward component 503 and a second backward component 504. The first forward component 501 and the first backward component 502 are associated with the first front loudspeaker 11 and the first rear loudspeaker 12. The second forward component 503 and the second backward component 504 are associated with the first front loudspeaker 11 and the second rear loudspeaker 13. As shown in FIG. 1, the first principal signal 211 and the second principal signal 221 are provided to the first front loudspeaker 11, and the first front loudspeaker 11 is shared between two loudspeaker pairs (i.e., the loudspeaker pair of the first front loudspeaker 11 and the first rear loudspeaker 12, and the loudspeaker pair of the first front loudspeaker 11 and the second rear loudspeaker 13).

In this embodiment, the first forward component 501 and the first backward component 502 are respectively emitted in opposite directions along the first line segment L1. The second forward component 503 and the second backward component 504 are respectively emitted in opposite directions along the second line segment L2. The first line segment L1 and the second line segment L2 may be located on the plane that coincides with the baffle 30. The first forward component 501 and the second forward component 503 are respectively directed to the reflecting surface S and reflected to the occupants in the vehicle by the reflecting surface S, while the first backward component 502 and the second backward component 504 are directly emitted to the passengers in the vehicle. Through this configuration, the occupants can perceive that the sounds associated with the first forward component 501, the first backward component 502, the second forward component 503 and the second backward component 504 come from different positions in the vehicle so as to provide the passengers with stereo sound signals of the left and right channels and improve the quality of the audio experience.

In addition, the first front loudspeaker 11, the first rear loudspeaker 12 and the second rear loudspeaker 13 in the present invention are arranged in a triangle, and the first front loudspeaker 11 is closer to a reflecting surface S in the vehicle in comparison with the first rear loudspeaker 12 and the second rear loudspeaker 13 such that the first forward component 501 generated by the first front loudspeaker 11 and the first rear loudspeaker and the second forward component 503 generated by the first front loudspeaker 11 and the second rear loudspeaker 13 are respectively reflected by the reflecting surface S to focus on the front seat passenger and the driver. Therefore, the front seat passenger and the driver can perceive a stereo sound effect that is clear and focused. Furthermore, this arrangement also prevents the forward components from interfering with each other due to excessive reflections in the vehicle, as excessive reflections will affect the sound clarity associated with the forward components.

In this embodiment, the first directional radiation pattern RP1 and/or the second directional radiation pattern RP2 may present a specific shape (such as cardioid, hyper cardioid or super cardioid). The sound intensity associated with the first backward component 502 will be smaller than the sound intensity associated with the first forward component 501. The sound intensity associated with the second backward component 504 will be smaller than the sound intensity associated with the second forward component 503. In this way, the occupants in the vehicle perceive the first forward component 501 and the second forward component 503 as dominant sound signals.

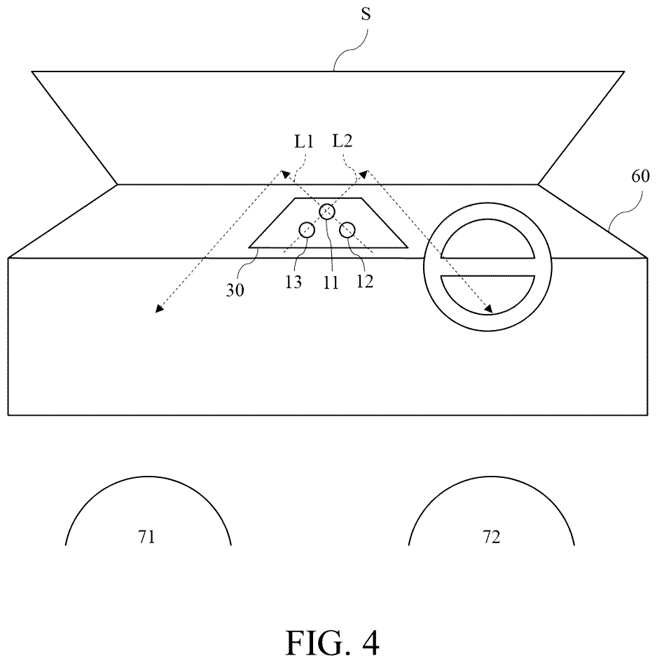

To illustrate a specific application of the audio system of the present invention for presenting stereo audio signals, this embodiment further provides an application scenario as illustrated in FIG. 1 and FIG. 4. The first front loudspeaker 11, the first rear loudspeaker 12 and the second rear loudspeaker 13 of the loudspeaker array 10 are installed in the central position of a dashboard 60 through the baffle 30 such that the loudspeaker array 10 is located between the front seat passenger 71 and the driver 72, and the loudspeaker array 10 is between the reflecting surface S and the front seat passenger 71 and between the reflecting surface S and the driver 72. An included angle is defined by the dashboard 60 and the reflecting surface S (such as the windshield of this car), and the included angle ranges between 40°and 80°. In an embodiment, the first front loudspeaker 11, the first rear loudspeaker 12 and the second rear loudspeaker 13 of the loudspeaker array 10 may also be directly installed on the dashboard 60 without the baffle 30. In addition, as shown in FIG. 4, in an embodiment, the connecting line from the first rear loudspeaker 12 to the second rear loudspeaker 13 is approximately parallel to the junction line of the reflecting surface S and the dashboard 60. The first front loudspeaker 11 receives the first principal signal 211 and the second principal signal 221, and the first rear loudspeaker 12 and the second rear loudspeaker 13 respectively receive the first accommodating signal 212 and the second accommodating signal 222, to generate a cardioid-shaped directional radiation pattern RP.

Referring to FIG. 1 and FIG. 4, the first forward component 501 of the first directional radiation pattern RP1 and the second forward component 503 of the second directional radiation pattern RP2 are emitted to the reflector S along the first line segment L1 and the second line segment L2 respectively, and reflected to the left side of the front seat passenger 71 (such as the left ear position) by the reflecting surface S and to the right side of the driver 72 (such as the right ear position) respectively. The first backward component 502 of the first directional radiation pattern RP1 and the second backward component 504 of the second directional radiation pattern RP2 are respectively emitted to the left side of the driver 72 (such as the left ear position) along the first line segment L1 and to the right side of the front seat passenger 71 (such as the right ear position) along the second line segment L2. In this way, the front seat passenger 71 and the driver 72 can simultaneously perceive the left channel and the right channel from different positions in the vehicle such that the left and right ears of the front seat passenger 71 and the driver 72 can respectively detect different left and right channels to increase the three-dimensional presence effect and improve the quality of the audio experience. In this embodiment, the accommodating signal can be generated by applying a delay to the corresponding principal signal, wherein the applied delay may be changeable to change the zero point (e.g., pole position) of the first directional radiation pattern RP1 and the second directional radiation pattern RP2. Changing the zero point allows the audio effects, such as stereo sounds from a loudspeaker pair that are reflected in different directions, to be changed and customized to match specific car configurations and specific passenger positions within the car.

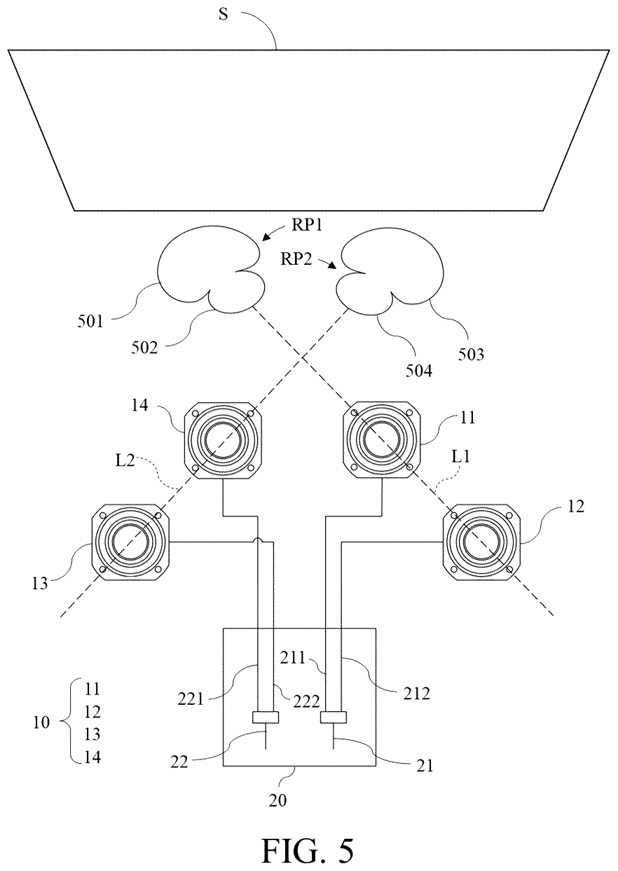

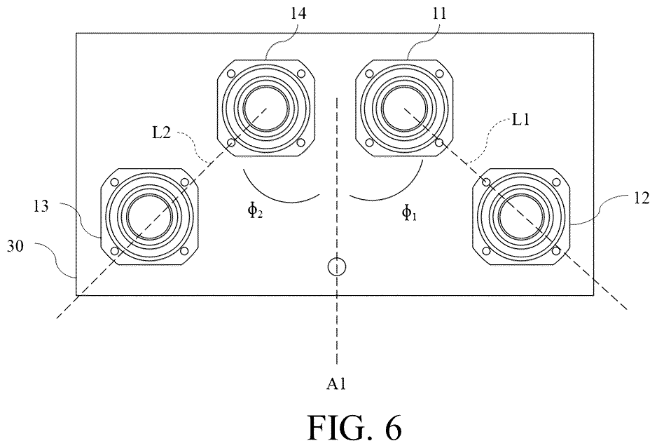

FIG. 5 and FIG. 6 illustrate an audio system for a vehicle according to a second embodiment of the present invention. The second embodiment is similar to the first embodiment (as shown in FIG. 1 to FIG. 4), and the difference is that the loudspeaker array 10 of the embodiment further comprises a second front loudspeaker 14. In this embodiment, the second front loudspeaker 14 is installed on the baffle 30 and is located between the first front loudspeaker 11 and the second rear loudspeaker 13. The second front loudspeaker 14 is offset from the first rear loudspeaker 12 and the second rear loudspeaker 13 (such as horizontally offset). The first front loudspeaker 11 and the first rear loudspeaker 12 constitute the first loudspeaker pair, and the second front loudspeaker 14 and the second rear loudspeaker 13 constitute a second loudspeaker pair. In this embodiment, the two loudspeaker pairs do not share the same front loudspeaker. The second front loudspeaker 14 is closer to the reflecting surface S in the vehicle in comparison with the first rear loudspeaker 12 and the second rear loudspeaker 13. The spacing distance between the second front loudspeaker 14 and the first front loudspeaker 11 is smaller than the spacing distance between the first rear loudspeaker 12 and the second rear loudspeaker 13 such that the second front loudspeaker 14, the first rear loudspeaker 12 and the second rear loudspeaker 13 are arranged in the form of an equilateral triangle, an isosceles triangle or an unequal triangle on the baffle 30, and the first front loudspeaker 11, the first rear loudspeaker 12 and the second rear loudspeaker 13 are arranged in the form of an equilateral triangle, an isosceles triangle or an unequal triangle on the baffle 30. In addition, the second front loudspeaker 14, the first front loudspeaker 11, the first rear loudspeaker 12 and the second rear loudspeaker 13 are arranged on the baffle 30 in the form of a trapezoid, such as an isosceles trapezoid. That is, the connecting line from the second front loudspeaker 14 to the first front loudspeaker 11 is parallel to the connecting line from the first rear loudspeaker 12 to the second rear loudspeaker 13. In an embodiment, the first front loudspeaker 11, the second front loudspeaker 14, the first rear loudspeaker 12 and the second rear loudspeaker 13 can be installed on the dashboard 60 through the baffle 30. Furthermore, the connecting line from the first rear loudspeaker 12 to the second rear loudspeaker 13, or the connecting line between the first front loudspeaker 11 and the second front loudspeaker 14, is approximately parallel to the junction line of the reflecting surface S and the dashboard 60.

In this embodiment, the acoustic center of the first front loudspeaker 11 and the acoustic center of the first rear loudspeaker 12 are defined as a first line segment L1, and the connection from the acoustic center of the second front loudspeaker 14 to the acoustic center of the second rear loudspeaker 13 is defined as a second line segment L2. An included angle is defined by the first line segment L1 and the second line segment L2. Through the different spacing distances among the first front loudspeaker 11, the first rear loudspeaker 12, the second front loudspeaker 14 and the second rear loudspeaker 13, an included angle between the first line segment L1 and the second line segment L2 can range between 90°and 100°or range between 60°and 140°so as to adapt to different installation spaces.

In this embodiment, a first reference included angle Φ1 and a second reference included angle Φ2 constitute the included angles defined by the first line segment L1 and the second line segment L2. In this embodiment, the first reference included angle Φ1 may be the same as or different from the second reference included angle Φ2, and the first reference included angle Φ1 and the second reference included angle Φ2 may range between 45°and 50°or range between 30°and 70°. In this embodiment, the spacing distance between the first front loudspeaker 11 and the first rear loudspeaker 12 and the spacing distance between the second front loudspeaker 14 and the second rear loudspeaker 13 are respectively set to a quarter wavelength of an operating frequency of the audio system of the present invention.

As shown in FIG. 5, in this embodiment, the audio signal processing system 20 is configured to supply the first principal signal 211 and the first accommodating signal 212 of the first audio channel 21 to the first front loudspeaker 11 and the first rear loudspeaker 12 respectively, and the audio signal processing system 20 is configured to supply the second principal signal 221 and the second accommodating signal 222 of the second audio channel 22 to the second front loudspeaker 14 and the second rear loudspeaker 13 respectively such that the loudspeaker array 10 generates a directional radiation pattern RP directed to the reflecting surface S. In this embodiment, the first forward component 501 and the first backward component 502 of the first directional radiation pattern RP1 of the directional radiation pattern RP are associated with the first front loudspeaker 11 and the first rear loudspeaker 12, and the second forward component 503 and the second backward component 504 of the second directional radiation pattern RP2 of the second directional radiation pattern RP are associated with the second front loudspeaker 14 and the second rear loudspeaker 13.

The first audio channel 21 is configured to provide the first principal signal 211, which is an unprocessed signal corresponding to the first audio channel 21. In addition, based on the first audio channel 21, the first accommodating signal 212 is generated. The first accommodating signal 212 is a signal processed and provided to the first audio channel 21, or is the processed first principal signal 211. The second audio channel 22 is configured to provide the second principal signal 221, which is an unprocessed signal corresponding to the second audio channel 22. In addition, based on the second audio channel 22, a second accommodating signal 222 is generated. The second accommodating signal 222 is a signal processed and provided to the second audio channel 22, or is the processed second principal signal 221.

As shown in FIG. 5, in this embodiment, the first accommodating signal 212 and the second accommodating signal 222 of the present invention are generated by using various approaches. In some embodiments, the audio signal processing system 20 comprises a signal inverter for generating the first accommodating signal 212 and/or the second accommodating signal 222. Or, alternatively, a delay or phase shift is applied to the first principal signal 211 or the second principal signal 221 to generate the first accommodating signal 212 or the second accommodating signal 222. The first accommodating signal 212 and/or the second accommodating signal 222 may be generated by applying different delays. For example, in some embodiments, the first accommodating signal 212 and the second accommodating signal 222 may be generated by applying a 0.05 to 0.5 ms (milliseconds) delay to the first principal signal 211 and the second principal signal 221. In addition, one or more filters may be applied to the first principal signal 211 and/or the second principal signal 221 to generate the first accommodating signal 212 and/or the second accommodating signal 222. The filtering process of the one or more filters may comprise low-pass filtering, high-pass filtering, band-pass filtering, etc. In addition to inverting, supplying delay to and filtering, the accommodating signal can also be mixed, additively accommodating and voltage level accommodating by a Digital Signal Processor (DSP) or other processing circuits. It should be noted that one or more wave guides may also be utilized to further control the orientation of the audio generated by the loudspeaker array 10. As shown in FIG. 5, the emitting direction of the first forward component 501 (along the first line segment L1) is different from the emitting direction of the second forward component 503 (along the second line segment L2).

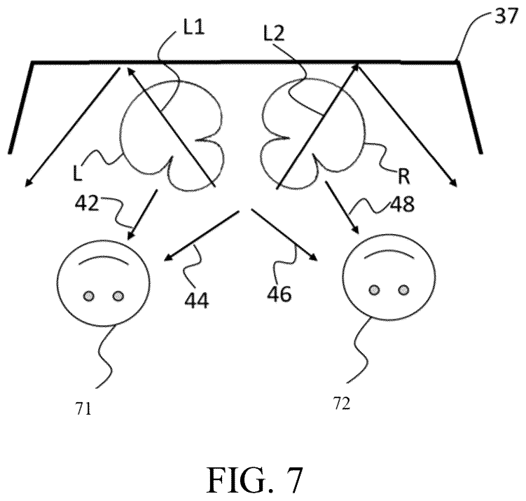

FIG. 7 illustrates a schematic diagram of the audio generated by the audio system and the transmission of audio to the occupants in the vehicle. FIG. 7 does not show the actual loudspeaker array. Instead, FIG. 7 shows the cardioid directional radiation patterns L, R of two loudspeaker pairs and an included angle between the emitting directions (e.g., along the first line segment L1 and the second line segment L2 as shown in FIG. 1 and FIG. 5) of the two loudspeaker pairs. For example, if a loudspeaker array is installed on the dashboard of the vehicle, wherein the first front loudspeaker 11 and the second front loudspeaker 14 are in front of the first rear loudspeaker 12 and the second rear loudspeaker 13, the cardioid directional radiation patterns L, R are generated upwards in the forward direction (for example, toward the windshield 37 of the vehicle). The corresponding left and right channels of the stereo sound signal are then reflected by the windshield 37 in different directions and are directed to the occupant positions (for example, the positions of the driver 72 and the front seat passenger 71) such that the occupants can perceive the left and right channels from one or more reflecting surfaces in the vehicle. A small amount of energy, as indicated by the arrow 44 (corresponding to the second backward component 504) and the arrow 46 (corresponding to the first backward component 502), will be emitted directly to the occupants without reflection. That is, the energies represented by the two arrows 44, 46 are respectively associated with the second backward component 504 and the first backward component 502. In addition, the directional radiation pattern has a zero point, as indicated by arrows 42, 48 in the corresponding area and associated direction, and the minimum energy is emitted to the occupants of the vehicle by the loudspeaker pairs of the loudspeaker array.

As shown in FIG. 7, from the perspective of the driver 72 located on the right, the direct energy of the cardioid directional radiation pattern R from the left loudspeaker pair (i.e., the direct energy from the first front loudspeaker 11 and the second rear loudspeaker 13 as shown in FIG. 1, or the direct energy from the second front loudspeaker 14 and the second rear loudspeaker 13 as shown in FIG. 5) directly perceived by the driver 72 is low. This is due to the fact that the zero point is pointed directly (the arrow 48) at the driver 72. Thus, the driver 72 primarily receives energy from the reflection of the second forward component 503 from the windshield 37, and the driver 72 will perceive the sound emitted by the left loudspeaker pair to be located on his right (right ear position). In addition, the left side of the driver 72 will receive a lower energy level (e.g., the first backward component 502, as indicated by the arrow 46) of the cardioid directional radiation pattern L directly from the right pair of loudspeakers (i.e., from the first front loudspeaker 11 and the first rear loudspeaker 12 as shown in FIG. 1 or FIG. 5). Thus, the driver 72 can perceive that the sound emitted by the right loudspeaker pair is located on his left side (left ear position). The same analysis method can be applied to the position of the front seat passenger 71. As discussed above, the windshield 37 can serve as a sound reflecting surface for the interior of this vehicle. In addition, sound reflecting surfaces may include the headliners, side windows, doors, rear windows, shelves, seat backs, etc., in the vehicle.

Via the modulation of the processing method, the accommodating signal provided to the rear loudspeaker of the loudspeaker pair is generated, and the shape of the resulting directional radiation pattern is also changed accordingly, such as generating a super cardioid directional radiation pattern or a hyper cardioid directional radiation pattern. The super cardioid directional radiation pattern comprises a large back lobe and zero points at 110°and 250°, while the hyper cardioid directional radiation pattern comprises better directional characteristics in comparison with the cardioid directional radiation pattern. At the same time, the hyper cardioid directional radiation pattern comprises zero points at 127°and 233°. Via the modulation of different parameters in the audio system, different directional radiation patterns are generated such that characteristics such as the positions of the zero points can be changed. These parameters can be controlled to customize the sound projection of a vehicle's audio system to better match the characteristics of the interiors of specific vehicles. In some embodiments, modulation applied to adjust the delay of the signal can change the shape of the resulting directional radiation pattern. Conversely, the spacing distance of the loudspeakers in the loudspeaker pair can also be accommodating to change the shape of the resulting directional radiation pattern. In one embodiment, the delay applied to the adjustment signal ranges between 0.1 ms and 0.13 ms, and the spacing distance of the loudspeakers in a loudspeaker pair ranges between 8 cm and 10 cm. In this embodiment, the resulting directional radiation pattern is a pattern between a hyper cardioid and a super cardioid pattern, where the zero point is at about 115°.

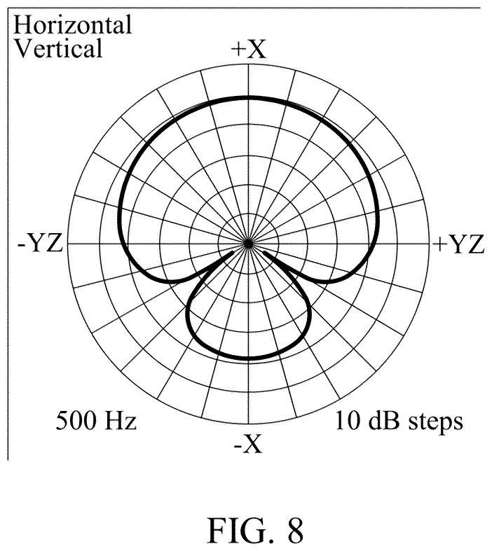

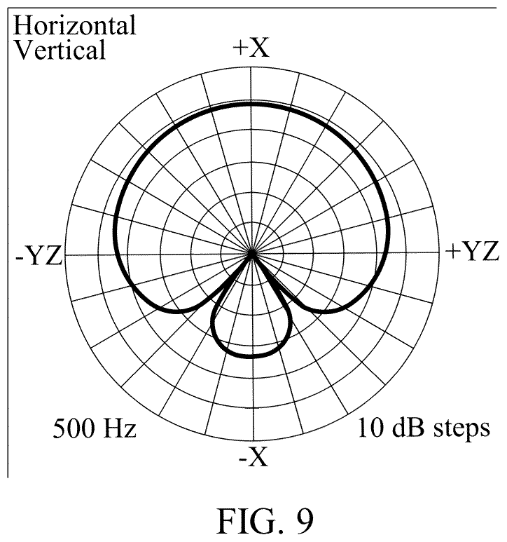

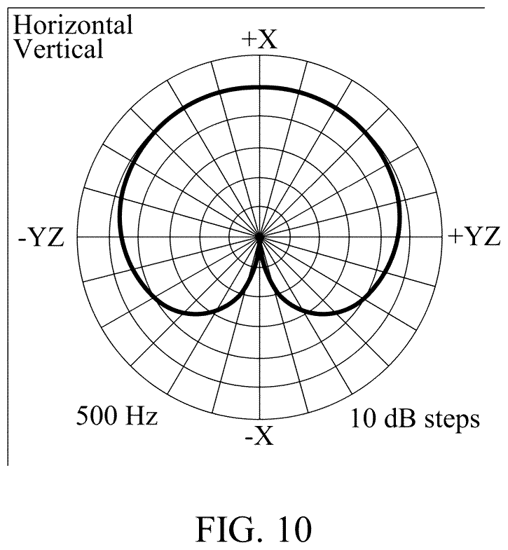

FIGS. 8 to 10 illustrate examples of the different directional radiation patterns that are generated by modulating the delay provided to the principal signal to generate the corresponding accommodating signal. For example, in the radiation pattern as shown in FIG. 8, the delay corresponding to the accommodating signal is 0.1 ms (millisecond). The delay corresponding to the accommodating signal is 0.12 ms in the radiation pattern, as shown in FIG. 9, while the delay corresponding to the accommodating signal is 0.26 ms in the radiation pattern as shown in FIG. 10. It is apparent that as the delay increases, the back lobe becomes less pronounced and the zero point is shifted backward. Variations in the applied delay can be used to generate different polarized radiation patterns to allow modulation to be installed into different audio systems.

Although the examples of the embodiment have been described for the three loudspeakers and four loudspeakers, any other number of loudspeakers can also be used. For example, different numbers of loudspeakers and loudspeaker arrays can be located at different locations within the vehicle to improve the sound quality and sound directionality. In addition, the spatial configuration of the specific loudspeakers and the rest of the loudspeakers within the array may provide for operation within a dedicated frequency band (e.g., by employing the frequency dependence of sound directionality). The loudspeaker/driver can be installed in positions including on the dashboard, the trunk, the door, the shelf, or any other suitable location. It is also possible to have more than two loudspeaker pairs that provide the principal signals and the accommodating signals to generate directional radiation patterns.

A detailed description of an audio system for a vehicle and a vehicle having the audio system provided by embodiments of the present invention are described above. For a person having ordinary skill in the art, according to the concepts of the embodiments of the present invention, there will be variations in the specific implementation and scope of application. In summary, the contents of this disclosure should not be construed as a limitation of the present invention, and all equivalent modifications or alterations made in accordance with the concept and technical ideas of the present invention shall be covered by the scope of the claims of the present invention.

What is claimed is:

1. An audio system for a vehicle, comprising:
a loudspeaker array, comprising:
a first front loudspeaker;
a first rear loudspeaker; and
a second rear loudspeaker, wherein the first front loudspeaker, the first rear loudspeaker and the second rear loudspeaker are arranged in a triangle, and the first front loudspeaker is closer to a reflecting surface in comparison with the first rear loudspeaker and the second rear loudspeaker; and
an audio signal processing system, configured to process a plurality of audio channels,
wherein the audio signal processing system is configured to provide a first principal signal and a first accommodating signal of a first audio channel in the plurality of audio channels to the first front loudspeaker and the first rear loudspeaker respectively, and
wherein the audio signal processing system is configured to provide a second principal signal and a second accommodating signal of a second audio channel in the plurality of audio channels to the first front loudspeaker and the second rear loudspeaker respectively such that the loudspeaker array generates a directional radiation pattern and the directional radiation pattern is directed to the reflecting surface.

2. The audio system according to claim 1, wherein a connection from an acoustic center of the first front loudspeaker to an acoustic center of the first rear loudspeaker is defined as a first line segment, the connection from the acoustic center of the first front loudspeaker to an acoustic center of the second rear loudspeaker is defined as a second line segment, and an included angle between the first line segment and the second line segment ranges between 60°and 140°.

3. The audio system according to claim 1, wherein a first spacing distance is defined by the first front loudspeaker and the first rear loudspeaker, a second spacing distance is defined by the first front loudspeaker and the second rear loudspeaker, and the first spacing distance and the second spacing distance are respectively set to a quarter wavelength of an operating frequency of the audio system.

4. The audio system according to claim 2, wherein the directional radiation pattern further comprises:
a first directional radiation pattern; and
a second directional radiation pattern,
wherein the first directional radiation pattern comprises:
a first forward component; and a first backward component,
wherein the second directional radiation pattern comprises:
a second forward component; and
a second backward component,
wherein the first forward component and the first backward component are associated with the first front loudspeaker and the first rear loudspeaker,
wherein the second forward component and the second backward component are associated with the first front loudspeaker and the second rear loudspeaker, and
wherein the first forward component and the second forward component are respectively directed to the reflecting surface.

5. The audio system according to claim 4, wherein an intensity associated with the first backward component is smaller than an intensity associated with the first forward component, and an intensity associated with the second backward component is smaller than an intensity associated with the second forward component.

6. The audio system according to claim 1, wherein the first accommodating signal of the first audio channel is generated by filtering or inverting the first principal signal of the first audio channel, and the second accommodating signal of the second audio channel is generated by filtering or inverting the second principal signal of the second audio channel.

7. The audio system according to claim 1, wherein the first accommodating signal of the first audio channel is generated by applying a delay to the first principal signal of the first audio channel, and the second accommodating signal of the second audio channel is generated by applying a delay to the second principal signal of the second audio channel.

8. The audio system according to claim 1, wherein the reflecting surface is a windshield, a headliner, a side window, a door, a rear window, or a shelf of the vehicle.

9. The audio system according to claim 1, wherein the first front loudspeaker, the first rear loudspeaker and the second rear loudspeaker are installed on a dashboard, and a connecting line from the first rear loudspeaker to the second rear loudspeaker is parallel to a junction line between the reflecting surface and the dashboard.

10. The audio system according to claim 4, wherein the first forward component of the first directional radiation pattern is emitted along the first line segment and is reflected to the left side of a passenger by the reflecting surface, and the second forward component of the second directional radiation pattern is emitted along the second line segment and is reflected to the right side of a driver by the reflecting surface.

11. An audio system for a vehicle, comprising:
a loudspeaker array, comprising
a first front loudspeaker;
a second front loudspeaker;
a first rear loudspeaker; and
a second rear loudspeaker, wherein the first front loudspeaker, the first rear loudspeaker and the second rear loudspeaker are arranged in a triangle, the second front loudspeaker, the first rear loudspeaker and the second rear loudspeaker are arranged in another triangle, and the first front loudspeaker and the second front loudspeaker are closer to a reflecting surface in comparison with the first rear loudspeaker and the second rear loudspeaker; and
an audio signal processing system, configured to process a plurality of audio channels,
wherein the audio signal processing system is configured to provide a first principal signal and a first accommodating signal of a first audio channel in the plurality of audio channels to the first front loudspeaker and the first rear loudspeaker respectively, and
wherein the audio signal processing system is configured to provide a second principal signal and a second accommodating signal of a second audio channel in the plurality of audio channels to the second front loudspeaker and the second rear loudspeaker respectively such that the loudspeaker array generates a directional radiation pattern and the directional radiation pattern is directed to the reflecting surface.

12. The audio system according to claim 11, wherein the first front loudspeaker, the second front loudspeaker, the first rear loudspeaker and the second rear loudspeaker are arranged in a trapezoid.

13. The audio system according to claim 12, wherein the first front loudspeaker, the second front loudspeaker, the first rear loudspeaker and the second rear loudspeaker are installed on a dashboard, and a connecting line between the first rear loudspeaker and the second rear loudspeaker, or a connecting line between the first front loudspeaker and the second front loudspeaker, is parallel to a junction line between the reflecting surface and the dashboard.
